(19) United States
(12) Patent Application Publication
(10) Pub. No.: US 2014/0349117 A1
(43) Pub. Date: Nov. 27, 2014

(54) Wear-Resistant, High Durability Industrial Ceramic Cutting Edges and Tools made from Sintered Polycrystalline Composites Based on Aluminum Nitride

(71) Applicant: Surmet Corporation, Burlington, MA (US)

(72) Inventor: Suri A. Sastri, Lexington, MA (US)

(73) Assignee: Surmet Corporation, Burlington, MA (US)

(21) Appl. No.: 14/287,416

(22) Filed: May 27, 2014

Related U.S. Application Data
(60) Provisional application No. 61/827,698, filed on May 27, 2013.

(51) Int. Cl. C04B 35/83; B23B 5/00; C04B 35/80; B23B 51/00

(52) U.S. Cl. CPC C04B 35/83; B23B 51/00; B23B 5/00; C04B 35/806; B23B 2224/08
USPC 428/408; 51/307; 428/698; 51/309; 501/153; 501/89; 501/87; 501/152

(57) ABSTRACT

The invention pertains to hardware such as cutting tools with improved performance, wear-resistance and durability made from sintered polycrystalline aluminum nitride based ceramic composites containing secondary or dispersed phases for enhanced toughness. The articles of this invention provide good hardness, toughness, chemical inertness, thermal stability, lubricity, wear-resistance, and the ability to operate in the presence of liquid coolants, yielding good surface finish and long lifetime. The cutting tools of this invention are applicable to a wide range of industrial, biomedical, commercial and other applications.

### PRIORITY APPLICATION

This application claims priority under 35 U.S.C. §119(e) to U.S. Provisional Application No. 61/827,698, filed on May 27, 2013, the disclosure of which is expressly incorporated by reference herein in its entirety.

### BACKGROUND

The present invention relates to a ceramic cutting tool and a method for making the same. More specifically, it relates to a ceramic cutting tool substantially composed of sintered polycrystalline composites based on aluminum nitride.

Aluminum nitride has so far had some limited use in ceramic cutting tools. In U.S. Pat. No. 7,704,611, issued Apr. 27, 2010, entitled “Hard, Wear-resistant Aluminum Nitride Based Coating” Coddet et al. discuss the use of an aluminum nitride coating deposited through various processes including evaporation. The process requires doping the aluminum nitride coating with selected metal species. This patent discusses in detail the high thermal stability and enhanced hardness associated with the coating. However, the use of aluminum nitride as a coating does not substantially improve the toughness of the tool or its resilience to thermal failure.

In a related patent, U.S. Pat. No. 7,785,700, issued Aug. 31, 2010 entitled, “Surface-coated cutting tool” Okada et al. discuss the advantageous use of aluminum nitride coatings doped with chlorine to improve lubrication between the tool and the work piece. This extends tool life, particularly if the tool is used for dry cutting materials that tend to weld, or if chips and shavings must be ejected from the cutting site.

In U.S. Pat. No. 5,580,510, issued Dec. 3, 1996 entitled, “Method for Improving the Toughness of Silicon Carbide-based Ceramics” Tein and Hilmas improve the toughness of the ceramic material silicon carbide by adding aluminum nitride and alumina when mixing the precursor powders. Upon heat treatment, the resulting solid solution includes aluminum nitride polytypoids existing as a secondary phase, reinforcing the structure and increasing toughness. This approach demonstrates the use of aluminum nitride as an additive in the fabrication of parts used for industrial purposes, such as automotive engine components. However, this patent relies on the process of hot-pressing, which requires specialized dies.

While the above cutting tools exhibit satisfactory properties, at least in certain situations, there still remains the need to develop new and useful ceramic materials. This is especially true for ceramic materials that are useful as cutting tools.

In experimental work performed in-house at Surmet Corp. of Burlington, Mass. 01803 (the assignee of the present patent application) the inventors have considered the use of composites based on aluminum nitride as a component of a ceramic material useful as a cutting tool. Aluminum nitride is noted for its hardness, toughness, chemical inertness and lubricity, but it additionally has excellent thermal conductivity and thermal stability.

In light of this, it was believed that ceramic cutting tools made of composites of aluminum nitride would experience lower thermal stresses, thanks to the excellent heat transfer abilities of aluminum nitride, which serve to dissipate hot spots within the body of the cutting tool.

The primary purpose of adding secondary phases such as whiskers, fibers, needles or particles with high aspect ratio is to increase the fracture toughness via reinforcement. The dispersed or secondary phase manifests a sudden discontinuity in microstructure across which crack propagation is inhibited or hindered. Thus cracks that develop and propagate within the matrix are arrested or retarded by the presence of the secondary or dispersed phase.

The use of secondary phases is a common practice in the ceramic industry, and literature describes significant increases in the fracture toughness of ceramics and other materials through this approach. A related approach employs a dispersed phase with a thermal expansion coefficient that differs from that of the matrix. The mismatch generates a positive or compressive stress at the interface, which again serves to impede or hinder crack propagation. In either case it is necessary to ensure that thermal expansion mismatches are managed through careful selection and proportionate mixing of the precursors to prevent the onset of thermal expansion related failure.

The high thermal conductivity of aluminum nitride also makes it amenable to the use of coolants, unlike most ceramic materials including silicon carbide, which experience high thermal stresses and failure in the presence of coolant. As an example, a typical coolant employed in the presence of aluminum nitride machining is FLC-260, which is produced by Ferro Electronic Material Systems and which is a dilute, weakly basic water-based solution of alkanolamines.

Aluminum nitride also exhibits some favorable properties compared to the ceramic material cubic boron nitride. Cubic boron nitride is very hard, chemically inert, and has high thermal conductivity, and is therefore used in cutting tool applications. However, its lubrication properties are poor. Additionally, it is substantially more expensive than composites of aluminum nitride.

### ADVANTAGES

Cutting tools made of polycrystalline sintered composites of aluminum nitride would exhibit improved properties and performance. Aluminum nitride composites are hard materials and are therefore suitable for cutting metals and some ceramics. The presence of specially selected materials as secondary or dispersed phases within the aluminum nitride matrix provides it additional toughness.

The high thermal conductivity of aluminum nitride and the consequent ability of aluminum nitride composite articles to quickly dissipate hot spots within their own bodies, thus enhancing thermal management of both the cutting tool and the substrate being machined, afford several benefits that make such articles uniquely suited to high-quality cutting tools.

The dissipation of sharp thermal gradients causes aluminum nitride based composites to quickly relieve thermal stresses caused by differential material expansion at different temperatures. As a result, ceramic cutting tools fabricated of aluminum nitride based composites exhibit good dimensional stability when exposed to localized high temperatures in operation. Thus, the frequency of thermal failure in aluminum nitride composite cutting tools is much reduced, and their operational lifetimes longer than those of other ceramic cutting tools.

A second consequence is that aluminum nitride composites permit the use of higher cutting speeds. Not only does this reduce cutting time, thus introducing an economy into manufacturing processes, but it also yields machined parts with higher quality surface finishes.

The chemical and thermal stability of aluminum nitride based composites makes them suitable for use with metals that would otherwise weld, and, almost uniquely among ceramic cutting tools, permits them to operate in the presence of coolants. As such, cutting tools based on aluminum nitride composites are suited to a broad range of applications.

Finally, the nature of these cutting tools as sintered polycrystalline entities yield a benefit with respect to their own fabrication. Unlike single-crystal entities, polycrystalline entities can be manufactured by comparatively inexpensive processes such as sintering. Since sintering requires neither specialized dies nor growth furnaces, it represents a further reduction in cost and complexity of manufacture.

### SUMMARY OF THE INVENTION

In summary, the present invention is directed toward a cutting tool (and its method of manufacture) containing about 0.5 to 10 percent by volume specially selected materials distributed as a secondary or dispersed phase in a matrix composed of aluminum nitride. The composite based on aluminum nitride begins with precursor powders. The precursors in this case are aluminum nitride milled to a desired particle size, a set of secondary phase materials enumerated below, and present in the

In one embodiment, the article is a cutting insert comprising an alloy base with the cutting tool manifesting as the tips of the insert as illustrated in FIG. 1. This embodiment is suitable for turning tools and similar industrial applications.

In another embodiment, the article is a cutting insert completely fabricated from the aluminum nitride based composite.

In yet another embodiment, the article is a drill tool or drill bit exhibiting a range of geometries, suitable for industrial drills, oil and gas drills, and medical drills including bone drills.

In a related embodiment, the article is an industrial milling tool.

In a further embodiment, the article is a cutting edge that may be integrated into a knife, blade, scissors, or similar cutting tools. This embodiment is suitable for use in industrial machining tools, commercial cutting tools, and surgical tools.

### BRIEF DESCRIPTION OF DRAWINGS

The following is a brief description of the drawings that form a part of this patent application:

FIG. 1 is an isometric view of a style of ceramic cutting tool wherein the ceramic of this invention is useful as a cutting tool of this style.

### DETAILED DESCRIPTION OF THE INVENTION (ALL EMBODIMENTS)

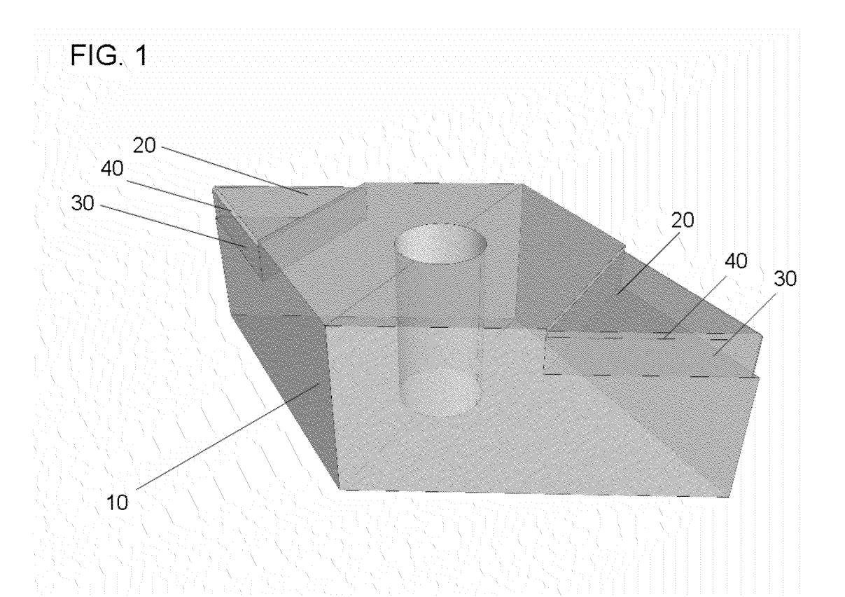

Referring to the drawings, FIG. 1 shows a style of cutting tool generally designated as 10. Cutting tool 10 has a rake face 20 and a flank face 30. The rake face 20 and the flank face 30 intersect to form a cutting edge 40 at the juncture thereof. Although this cutting tool 10 is shown as a generally rhomboid shape, it should be appreciated that the composition disclosed herein can be fabricated into other geometries of cutting tools.

The composition of cutting tool 20 includes a composite of aluminum nitride. The secondary or dispersed phase may consist of a ceramic material, in particular, silicon nitride, silicon carbide, boron nitride, titanium carbide, yttrium oxide, borides or nitrides of other transition metals, or carbon nanotubes or graphene, either singly or in combination. These secondary phases may be present in the form of whiskers, fibers, needles or generally particles with high aspect ratio. The secondary phases and the relevant forms thereof are selected on the basis of the required properties of toughness of the finished cutting tool, and the sintering conditions that can be generated with available equipment.

A sintering aid may be added to the precursor powder mixture. One exemplary sintering aid is yttrium oxide. Other sintering aids include magnesium oxide, calcium oxide, ytterbium oxide and combinations thereof.

Manufacture of the cutting tool based on aluminum nitride composite begins with the processing of precursor powders. The primary precursor is aluminum nitride powder. To serve as a useful precursor an average particle surface area of 4.5 square meters per gram to 7.5 square meters per gram, although surface areas in the range of 3 square meters per gram to 8 square meters per gram are permissible. The native oxygen content corresponding to this particle size distribution is in the range of 0.5 to 1.8 per cent. One of the purposes of sintering is the diffusive removal of oxygen from the aluminum nitride matrix.

The secondary phase exists as whiskers, fibers, needles or generally particles with high aspect ratio and may be present in quantities from 0.5 to 10 percent by volume of the overall powder mixture. The phase equilibria diagrams related to mixtures of the primary and secondary phase materials provide information about the appropriate sintering temperature and the proportionate quantity of secondary phase materials required for the formation of the composite, and is therefore to be consulted as part of the process of secondary phase selection. Suitable secondary phase materials are listed in the preceding paragraphs of this section and may be selected either singly or in combination for mixing.

Sintering aids play a role in the removal of gaseous oxygen and oxygenated species from the grain boundaries, improving both the purity and the thermal conductivity of the sintered aluminum nitride based composite. Sintering aids are generally selected on the basis of sintering temperature and may be present in a quantity of about 5 percent by weight of the overall powder mixture. Suitable sintering aids for the aluminum nitride system are listed in the preceding paragraphs of this section and may be selected either singly or in combination for mixing.

A mixture of aluminum nitride powder, secondary phase powder(s) and the sintering aid(s) may be prepared by conventional procedures such as attrition milling or dry ball milling. These powders are also generally amenable to wet ball milling with an appropriate solvent and suitable milling media. Appropriate solvents include ethanol, heptane, a blend of ethanol and chlorothene, or other organic liquids. Milling media, usually in the form of spheres a few millimeters in diameter, should have no significant adverse effect upon the components of the mixture or upon sintered bodies prepared from the mixture. After milling, the solvent may be removed through conventional procedures to yield a powder mixture suitable for conversion to a ceramic green body. Satisfactory results are achieved through oven drying or spray-drying.

An organic binder may be added during milling. Suitable binders are well known in the art and typically include high molecular weight organic materials soluble in organic solvents. Illustrative binders include polyethyloxazoline, industrial waxes such as paraffin, highly viscous polyglycols, polymethyl-methacrylate and polyvinyl butyral. A blend containing 35 to 65 weight percent, and permissibly 20 to 80 weight percent, polyethyloxazoline, with the balance containing polyethylene glycol, is particularly suitable. The binder is suitably added to the mixture components prior to milling.

Any well-known dispersing aid or dispersant may also be added during milling of the mixture. Fish oil is a particularly suitable dispersant.

The precursor powders are now shaped as required to produce the relevant cutting tool. Shaping can occur by any of several conventional procedures, including cold isostatic pressing, slip casting, die pressing, injection molding, extrusion, roll compaction or forming, or tape casting to produce a desired shape. The result of this step is the green body of the cutting tool.

The cutting tool green body is subjected to conditions suitable to the removal of the organic binder prior to sintering. Debinding, also known as binder burnout, generally requires the green body to be held at an elevated temperature such that the binder thermally decomposes. Suitable temperatures and hold times vary depending on the binder and the dimensions of the green body. Debinding can occur in vacuum, in air at ambient pressures, or under an inert atmosphere of nitrogen or a noble gas such as argon. Generally, binder burnout in nitrogen atmosphere results in less oxygen contamination in aluminum nitride. However, depending on the binder-type and conditions of binder burn-out, binder burnout in air is also acceptable.

Sintering occurs in a non-oxidizing atmosphere established by gaseous nitrogen or a source of gaseous nitrogen. The source of gaseous nitrogen may be gaseous ammonia, gaseous mixtures of nitrogen and ammonia, gaseous mixtures of nitrogen, ammonia or both with an inert or noble gas such as argon, or gaseous mixtures of nitrogen, ammonia or both with hydrogen and optionally, an inert or noble gas. A favorable sintering atmosphere may be established by placing the green body into a crucible fabricated from a refractory material, such as boron nitride, aluminum nitride, molybdenum metal or tungsten metal, prior to sintering and cooling. Alternately, the green body may be wrapped in a foil made of a refractory metal such as molybdenum. The refractory material will vary depending on the type of furnace used for sintering. Boron nitride and aluminum nitride are suitable for graphite furnaces, whereas molybdenum or tungsten metal are suitable for certain non-graphite furnaces.

Sintering may occur at a temperature of from about 1570 degrees Celsius to about 1850 degrees Celsius depending on the sintering aid and the properties of the phase mixture as determined from the phase equilibria diagram. Temperatures up to 2100 degrees Celsius are permissible, but require correspondingly designed high-temperature ovens, and may not be applicable to all secondary phase materials. The sintering temperature is maintained for a period of time sufficient to attain a density of at least 95 percent of theoretical density. Sintering time generally ranges from 2 to 10 hours, although sintering times ranging from 4 to 24 hours are permissible.

The sintered polycrystalline cutting tool is now sharpened, for example through the use of a bench grinder, grinding wheel or analogous device. Cutting tools based on composites of aluminum nitride can be sharpened using suitable grinding tools employing harder materials as part of their construction, including, but not limited to, silicon carbide and diamond. The position and motion of the cutting tool is controlled using a tool support typically present in tool fabrication facilities. Cooling fluid may be used as appropriate. Grinding and sharpening procedures typically require multiple passes, but the procedure is standardized and well-known to persons having ordinary skill in the art.

In the absence of a secondary phase, the hardness of aluminum nitride articles is on the order of 1170 kilograms per square millimeter according to the Knoop test with a 100 g mass. The fracture toughness is 3.5 Megapascals-square root meters. Thermal conductivity is at minimum 170 watts per meter-Kelvin and typically 230 watts per meter-Kelvin or higher.

Optionally, further manufacturing steps may occur, including the application of coatings to improve toughness, lubricity, biocompatibility, chemical inertness, or other properties. Conventional coating processes, including, but not limited to, physical vapor deposition and chemical vapor deposition are applicable to this step. As an example, the tool may be provided a lubricity-enhancing coating of diamond-like carbon, in conjunction with adhesion-enhancing layers of amorphous silicon nitride or silicon oxynitride.

### EMBODIMENTS

One embodiment, illustrated in FIG. 1, is a cutting insert, more specifically a turning insert, that comprises an alloy base to which tips fabricated of the aluminum nitride based composite as per the disclosure above have been bonded. Bonding can occur through conventional means, including, but not limited to, adhesive and mechanical means. The base is fabricated through conventional metal shaping means, and acts an insert that may be integrated into a cutting system. The insert contains a central hole through which it is attached to a holder, for example, through a cam-type mechanism. The rhomboid geometry illustrated in FIG. 1 is intended only as an example, and it is understood that the cutting edge can be integrated into inserts of variant geometries, including but not limited to shapes of circular, square or triangular cross-section.

In another embodiment, the insert of Example 1 is entirely fabricated from the aluminum nitride based composite through similar processing steps. The chief variation in the process steps for the fabrication of this cutting tool from the aluminum nitride based composite is geometric, and therefore requires adjustments to the step of green body formation. This may include the use of different mold geometries in the case of cold isostatic pressing or slip casting. A second adjustment may be required in the sinter step, specifically the sinter time, to account for parts of varying size.

In yet another embodiment, a drill tool or drill bit is fabricated of aluminum nitride composite. Again, the chief difference between this embodiment and others is largely geometric. The article of this embodiment can be fabricated in a range of generally cylindrical geometries of axial lengths that may optionally include flutes or threads. The variant geometries are suitable for industrial drills, oil and gas drills, and medical drills including bone drills. Optionally, coatings for further improved lubricity, hardness, chemical inertness or biocompatibility may be applied.

In a related embodiment, an industrial milling tool can be fabricated according to a very similar process.

In a further embodiment, a cutting edge that may be integrated into knives, blades, scissors, or similar cutting tools is fabricated of aluminum nitride composite. The processing steps for producing like articles represent a modification of the aforementioned examples that is again largely geometric. This embodiment can be fabricated in a range of generally thin, flat geometries. Straight or curved edges may be provided. The variant geometries are suitable for integration into industrial machine cutting tools. They are also suitable for a range of commercial cutting tools such as wet shaving razors, knives, needles or blades. They are additionally suitable for a wide range of surgical tools, including scalpels, osteotomes, elevators, scissors, saws, chisels, knives, dermatomes, rongeurs, trephines or trocars. Optionally, coatings for further improved lubricity, hardness, chemical inertness or biocompatibility may be applied.

### RAMIFICATIONS AND SCOPE

It is apparent that the article of this patent is a high-quality cutting edge or tool or device made from sintered polycrystalline composites based on aluminum nitride. It is also apparent that this article exhibits high hardness, toughness, chemical inertness, lubricity, and importantly, high thermal conductivity. It is further apparent that this article enables higher cutting speeds and thus high quality finishes, operates in the presence of coolant, and exhibits reduced thermal failure rate and improved wear resistance, dimensional stability and lifespan. It is finally apparent that the article of this patent is well suited to a range of industrial, biomedical and other cutting applications.

Other embodiments than those listed above will be apparent to those skilled in the art from a consideration of the specification disclosed herein. It is intended that the specification and the examples are illustrative only and are not intended to be limiting on the scope of the invention. The true scope and spirit of the invention is indicated by the following claims.

What is claimed is:

1. A cutting edge or tool or wear-resistant device composed of a sintered composite consisting of an aluminum nitride based ceramic matrix reinforced with specially selected secondary phases with high aspect ratio morphologies, such as whiskers, platelets, needles, fibers and nanofibrous architecture.

2. The article of claim 1 wherein the secondary or dispersed phases are composed of silicon nitride, silicon carbide, boron nitride, titanium carbide, titanium diboride, or borides and nitrides of other transition metals, carbon nanotubes, graphene or combinations thereof.

3. The article of claim 1 fabricated into a bit or an insert for a cutting tool.

4. The article of claim 1 wherein the cutting edge is integrated into an industrial turning, machine cutting, milling, drilling or boring tool.

5. The article of claim 1 wherein the cutting edge is integrated into a medical cutting tool, including a scalpel, osteotome, elevator, scissors, saw, chisel, knife, dermatome, rongeur, trephine or trocar.

6. The article of claim 1 wherein the cutting edge is integrated into an oil or gas drill string.

7. The article of claim 1 wherein the cutting edge is integrated into a wet shaving razor, knife, needle or blade.

8. The article of claim 1 to which coatings to enhance hardness, toughness, lubricity, chemical inertness or other characteristics have been applied.

9. The article of claim 8 in which the coating is composed of diamond-like carbon, with intermediate adhesion-enhancing layers such as amorphous silicon nitride and amorphous silicon oxynitride.

10. The article of claim 1 fabricated using conventional powder processing techniques.

11. The article of claim 1 densified through pressureless sintering or hot pressing approaches.

12. The article of claim 1 densified in the presence of sintering aids, including yttrium oxide, magnesium oxide, calcium oxide, ytterbium oxide, or combinations thereof.

13. The article of claim 1 densified in the presence of titanium diboride as a sintering aid for pressureless sintering.
